(19) United States
(12) Patent Application Publication
(10) Pub. No.: US 2018/0197151 A1
(43) Pub. Date: Jul. 12, 2018

(54) AUTOMATICALLY UPDATING AN ELECTRONIC CALENDAR

(71) Applicant: Microsoft Technology Licensing, LLC, Redmond, WA (US)

(72) Inventor: Prakash Pattanam Krishnaswamy, Hyderabad (IN)

(21) Appl. No.: 15/402,495

(22) Filed: Jan. 10, 2017

(51) Int. Cl. G06Q 10/10

(52) U.S. Cl. CPC G06Q 10/1095; G06Q 10/107

(57) ABSTRACT

Systems and methods for automatically updating an electronic calendar. One system includes a server including an electronic processor. The electronic processor is configured to detect an activation of an automatic reply for an account associated with a first user, wherein the automatic reply is associated with a duration. The electronic processor is further configured to, in response to detecting the activation, determine a second user different from the first user and automatically update the electronic calendar of the second user to include a calendar event occurring over at least a portion of the duration.

### FIELD

Embodiments described herein relate to electronic calendaring, and, more particularly, to automatically updating an electronic calendar based on automatic replies activated for accounts, such as email accounts.

### SUMMARY

Co-workers often use emails or other electronic forms of communication or messaging to plan for, schedule, and coordinate events as well as related projects. From time to time, a particular worker may be unavailable. In some embodiments, unavailable means that the worker is out of the office, inaccessible, or preoccupied. When a particular worker is unavailable, co-workers may waste time and resources. For example, when a worker does not know that a co-worker is unavailable, the worker may send a task request to the co-worker and may assume that the task is being handled. As another example, a worker may schedule a meeting with a co-worker without knowing that the co-worker is unavailable. Accordingly, in these and other examples, worker productivity suffers since time is wasted waiting on unavailable workers and re-assigning and re-scheduling tasks.

To address this concern, some electronic communication services, such as email message services, transmit an automatic reply (for example, an out-of-office notification) in response to communications received during a predetermined time period, during which period the recipient of the communication is unavailable. The automatic reply informs a sender of a communication that the recipient is unavailable. However, by the time the sender receives the automatic reply, the sender may have already wasted time and effort initially creating the communication or taking other preparatory actions. For example, a sender may coordinate a meeting with multiple individuals only to eventually discover that the recipient, who is necessary for the meeting, is unavailable.

Thus, embodiments described herein provide, among other things, systems and methods for automatically updating an electronic calendar and, in particular, automatically updating an electronic calendar in response to activation of an automatic reply for an account. For example, when an automatic reply is activated for an account of a first user, the systems and methods may automatically update an electronic calendar of a second user (different than the first user) to include a calendar event that informs the second user of the first user's unavailability. The duration of the calendar event may match the duration of the automatic reply. Since the calendar event marks the unavailability of the first user as compared to the second user, the calendar event included in the second user's electronic calendar may categorize the event time as “available” time. Categorizing the event as available time in the second user's electronic calendar prevents the second user or other users accessing the second user's calendar from assuming that the second user is unavailable during this time.

For example, one embodiment provides a system for automatically updating an electronic calendar. The system includes a server including an electronic processor. The electronic processor is configured to detect an activation of an automatic reply for an account associated with a first user. The automatic reply is associated with a duration. The electronic processor is configured to, in response to detecting the activation, determine a second user different from the first user and automatically update the electronic calendar of the second user to include a calendar event occurring over at least a portion of the duration.

Another embodiment provides a method for automatically updating an electronic calendar. The method includes detecting, with an electronic processor, an activation of an automatic reply for an account associated with a first user. The automatic reply is associated with a duration. The method also includes, in response to detecting the activation of the automatic reply, determining, with the electronic processor, a second user different from the first user and automatically updating the electronic calendar of the second user to include a calendar event. The calendar event occurs over at least a portion of the duration and is categorized as available time.

Another embodiment provides a non-transitory computer-readable medium including instructions executable by an electronic processor to perform a set of functions. The set of functions includes detecting an activation of an automatic reply for an account associated with a first user. The automatic reply is associated with a duration during which the first user is unavailable to receive communications through the account. The set of functions further includes, in response to detecting the activation of the automatic reply, determining a second user different from the first user, wherein the second user represents a frequent correspondent with the first user via the account associated with the first user and automatically updating an electronic calendar of the second user to include a calendar event. The calendar event occurs over at least a portion of the duration and is categorized as available time.

### BRIEF DESCRIPTION OF THE DRAWINGS

FIG. 1 schematically illustrates a system for automatically updating an electronic calendar according to some embodiments.

FIG. 2 schematically illustrates a server included in the system of FIG. 1 according to some embodiments.

FIG. 3 is a flowchart illustrating a method of automatically updating an electronic calendar performed by the system of FIG. 1 according to some embodiments.

FIG. 4 illustrates a graphical user interface for activating an automatic reply for an account according to some embodiments of the invention.

FIGS. 5 and 6 illustrate graphical user interfaces displaying an electronic calendar according to some embodiments of the invention.

### DETAILED DESCRIPTION

One or more embodiments are described and illustrated in the following description and accompanying drawings. These embodiments are not limited to the specific details provided herein and may be modified in various ways. Furthermore, other embodiments may exist that are not described herein. Also, the functionality described herein as being performed by one component may be performed by multiple components in a distributed manner. Likewise, functionality performed by multiple components may be consolidated and performed by a single component. Similarly, a component described as performing particular functionality may also perform additional functionality not described herein. For example, a device or structure that is “configured” in a certain way is configured in at least that way, but may also be configured in ways that are not listed. Furthermore, some embodiments described herein may include one or more electronic processors configured to perform the described functionality by executing instructions stored in non-transitory, computer-readable media. Similarly, embodiments described herein may be implemented as non-transitory, computer-readable media storing instructions executable by one or more electronic processor to perform the described functionality.

In addition, the phraseology and terminology used herein is for the purpose of description and should not be regarded as limiting. For example, the use of “including,” “containing,” “comprising,” “having,” and variations thereof herein is meant to encompass the items listed thereafter and equivalents thereof as well as additional items. The terms “connected” and “coupled” are used broadly and encompass both direct and indirect connecting and coupling. Further, “connected” and “coupled” are not restricted to physical or mechanical connections or couplings and can include electrical connections or couplings, whether direct or indirect. In addition, electronic communications and notifications may be performed using wired connections, wireless connections, or a combination thereof and may be transmitted directly or through one or more intermediary devices over various types of networks, communication channels, and connections. Moreover, relational terms such as first and second, top and bottom, and the like may be used herein solely to distinguish one entity or action from another entity or action without necessarily requiring or implying any actual such relationship or order between such entities or actions.

As described above, when a user is going to be unavailable, the user may set up an automatic reply that is automatically transmitted in response to received communications, such as received email messages. In some embodiments, unavailable means that the user is out of the office, inaccessible, or preoccupied. The automatic reply informs a sender of the received communication that the recipient is unavailable. In some situations, however, by the time the sender receives an automatic reply, the sender may have already wasted time and effort.

Accordingly, when an automatic reply is activated for an account for a first user, embodiments described herein automatically update the electronic calendar of a second user (different from the first) to give the second user advance notice of the first user's unavailability. Thus, the second user is informed of the first user's unavailability even before the second user composes or transmits a communication to the first user.

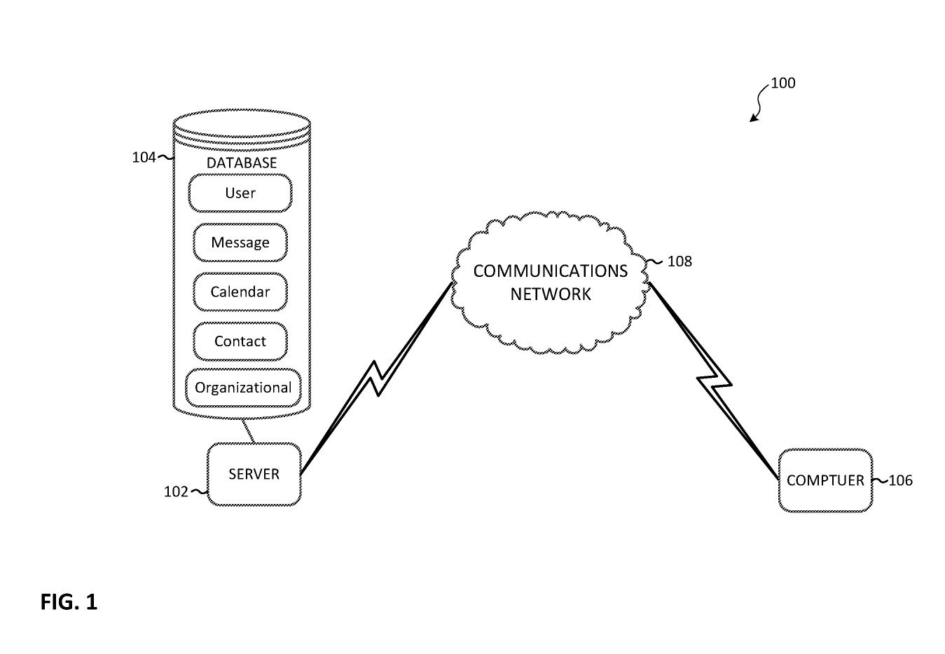

For example, FIG. 1 schematically illustrates a system 100 for updating an electronic calendar. As illustrated in FIG. 1, the system 100 includes a server 102, a database 104, and a computer 106. It should be understood that the system 100 is provided as an example and, in some embodiments, the system 100 may include additional components. For example, the system 100 may include multiple servers 102, multiple databases 104, multiple computers 106, or a combination thereof.

The server 102 and the computer 106 are communicatively coupled via a communications network 108. The communications network 108 may be implemented using a wide area network, such as the Internet, a local area network, such as a Bluetooth™ network or Wi-Fi, a Long Term Evolution (LTE) network, a Global System for Mobile Communications (or Groupe Spécial Mobile (GSM)) network, a Code Division Multiple Access (CDMA) network, an Evolution-Data Optimized (EV-DO) network, an Enhanced Data Rates for GSM Evolution (EDGE) network, a 3 G network, a 4 G network, and combinations or derivatives thereof.

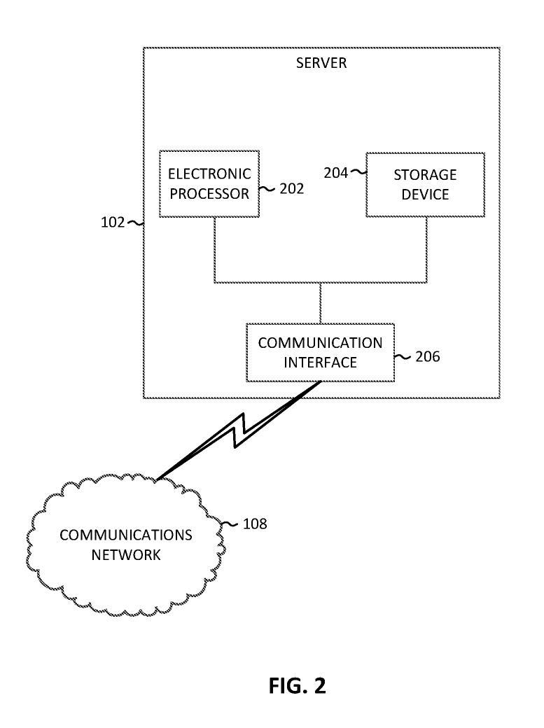

FIG. 2 schematically illustrates the server 102 in more detail. As illustrated in FIG. 2, the server 102 includes an electronic processor 202, a storage device 204, and a communication interface 206. The electronic processor 202, the storage device 204, and the communication interface 206 communicate over one or more communication lines or buses, wirelessly, or a combination thereof. It should be understood that the server 102 may include additional components than those illustrated in FIG. 2 in various configurations and may perform additional functionality than the functionality described in the present application. Also, it should be understood that the functionality described herein as being performed by the server 102 may be distributed among multiple devices, such as multiple servers, and may be provided through a cloud computing environment or accessible by components external to the system 100 via the communications network 108.

The electronic processor 202 may include a microprocessor, application-specific integrated circuit (ASIC), or another suitable electronic device. The electronic processor 202 is configured to retrieve from the storage device 204 and execute, among other things, software related to the processes and methods described herein. The storage device 204 includes a non-transitory, computer-readable storage medium. As used herein, the term “non-transitory computer readable medium” comprises all computer-readable media except for a transitory, propagating signal. Accordingly, a non-transitory computer-readable medium may include, for example, a hard disk, a CD-ROM, an optical storage device, a magnetic storage device, a ROM (Read Only Memory), a RAM (Random Access Memory), a register memory, a processor cache, or any combination thereof. As illustrated in FIG. 2, the communication interface 206 may include a transceiver (for example, a Wi-Fi or Ethernet transceiver) for communicating over the communications network 108 and, optionally, one or more additional wired or wireless communication networks or connections.

The computer 106 is a personal computing device (for example, a desktop computer, a laptop computer, a terminal, a tablet computer, a smart telephone, a wearable device, or the like) that includes similar components as the server 102. In some embodiments, the computer 106 is used by a user to access functionality provided by the server 102 via the communications network 108. The computer 106 may access the functionality provided by the server 102 using a web-browser, a dedicated software client, or the like.

The functionality provided by the server 102 may include a communication or messaging service, such as an email messaging service, an instant messaging service, or the like, and, optionally, a calendaring service that manages an electronic calendar. An electronic calendar is a software-based calendar that establishes and tracks calendar events. In some embodiments, calendar events include appointments, meetings, conference calls, holidays, vacations, and the like. In some embodiments, the functionality provided by the server 102 also includes task management services, contact management services, and the like. For example, in some embodiments, the server 102 provides a suite of messaging, calendaring, task, and contact services, such as the serves offered through Outlook® provided by Microsoft Corporation.

As illustrated in FIG. 1, to provide the above services, the server 102 may communicate with the database 104. The database 104 may be a database housed on a suitable database server communicatively coupled to and accessible by the server 102. In alternative embodiments, the database 104 may be part of a cloud-based database system external to the system 100 and accessible by the server 102 over one or more additional networks. Also, in some embodiments, all or part of the database 104 may be locally stored on the server 102 (for example, within the storage device 204).

In some embodiments, as illustrated in FIG. 1, the database 104 electronically stores user data and communication or message data. In some embodiments, the database 104 also stores calendar data, contact data, organizational data, or a combination thereof. It should be understood that, in some embodiments, the data stored in the database 104 is distributed among multiple databases that communicate with the server 102 and, optionally, each database may store specific data used by the server 102 as described herein. For example, in some embodiments, the database 104 is distributed as a user database, a message database, a calendar database, a contact database, an organizational database, or a combination thereof.

The user data identifies users of the server 102 (users authorized to access and use the functionality provided by the server 102). For example, the user data may include user account information (for example, a user identifier and password), security permissions, and pointers linking individual users to other data, such as message data, calendar data, contact data, and organizational data. For example, the user data may indicate an account of a user, such as an email address. The user data may also include user settings for the account of the user, including whether an automatic reply for a user's account is activated or deactivated.

The message data includes communications associated with one or more accounts. For example, the message data may include email messages, voicemail messages, text messages, instant messages, or combinations thereof. The message data may include communications sent to and from the users of the server 102.

The calendar data includes calendar events, which may represent a meeting, a conference call, or another type of appointment or allocation of time. Each calendar event may include a title or description (for example, “Budget Meeting”), a duration (for example, a start time and, optionally, an end time), an optional list of participants (other users who have been informed of the event and may be attending the event), and, optionally, other information regarding the event (for example, notes, documents, and the like). Each calendar event, or a portion thereof, may also include a time category. For example, in some embodiments, each calendar event may be categorized as either “available” time or “unavailable” time, which, specifies, respectively, whether a user is available or unavailable during the calendar event. For example, a user may add a calendar event for a vacation and may categorize the event, or a portion thereof, as “available” time when the user is open to receiving communications, performing work, or participating in meetings during this time. It should be understood that more than two categories may be used for calendar events and different phraseology may be used. For example, a calendar event may be categorized as “busy” time or “free” time rather than “unavailable” time or “available” time.

The contact data includes contact information, such as names, addresses, email addresses, phone numbers, and the like. Contact data may also include category information regarding a contact. For example, a contact may be designated (for example, manually), as a “favorite,” “family,” a “friend,” a “co-worker,” or the like. The organizational data may identify groups of users or other relationships between users. For example, the organizational data may specify whether one or more users are members of the same group, a manager or supervisor of a user, and the like. In some embodiments, organizational data may be included as part of the contact data or vice versa.

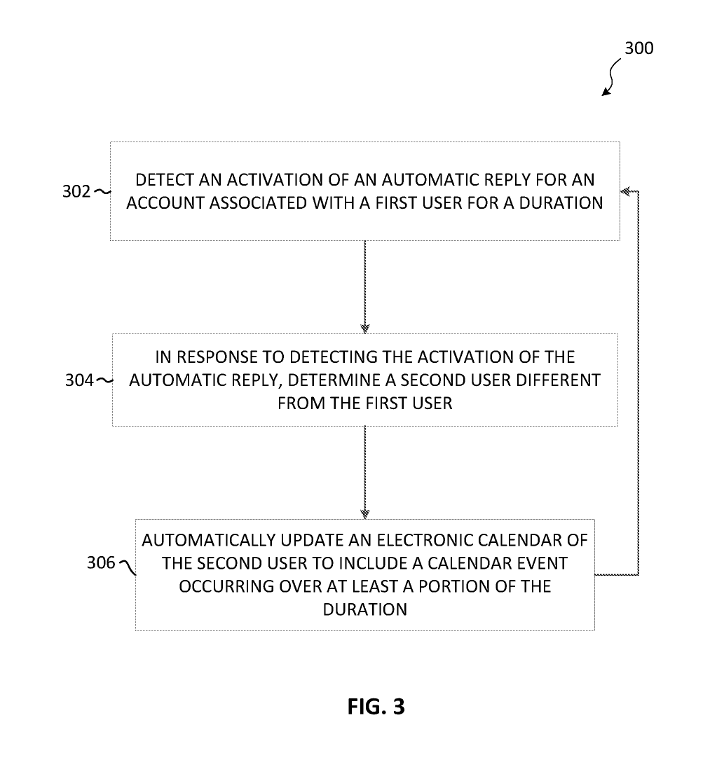

As described above, as part of the messaging service provided by the server 102, the server 102 may allow a user to activate an automatic reply, such as an out-of-office notification, for an account. An account is an electronic account for sending and receiving communications to and from the first user. In one embodiment, the account is an email account. In other embodiments, the account may be an electronic messaging account associated with a phone number, a screen name, or another unique identifier for the first user. In response activation of an automatic reply, the server 102 automatically transmits an automatic reply to any communication received for the account. In addition, the server 102 automatically updates one or more electronic calendars. For example, FIG. 3 illustrates a method 300 of updating an electronic calendar according to one embodiment. The method 300 is described as being performed by the server 102 and, in particular, the electronic processor 202. However, it should be understood that in some embodiments, portions of the method 300 may be performed by other devices, including for example, the computer 106.

As illustrated in FIG. 3, at block 302, the electronic processor 202 detects activation of an automatic reply for an account associated with a first user. The automatic reply is associated with a duration, which includes a start time and, optionally, an end time. During this time, the automatic reply is transmitted in response to communications received for the account of the first user. The automatic reply may include text that specifies the first user, the duration, and other information, such as the fact that the first user is unavailable to receive communications through the account during the duration. The automatic reply may also include text providing alternative ways to contact or communicate with the first user or individuals to contact in place of the first user.

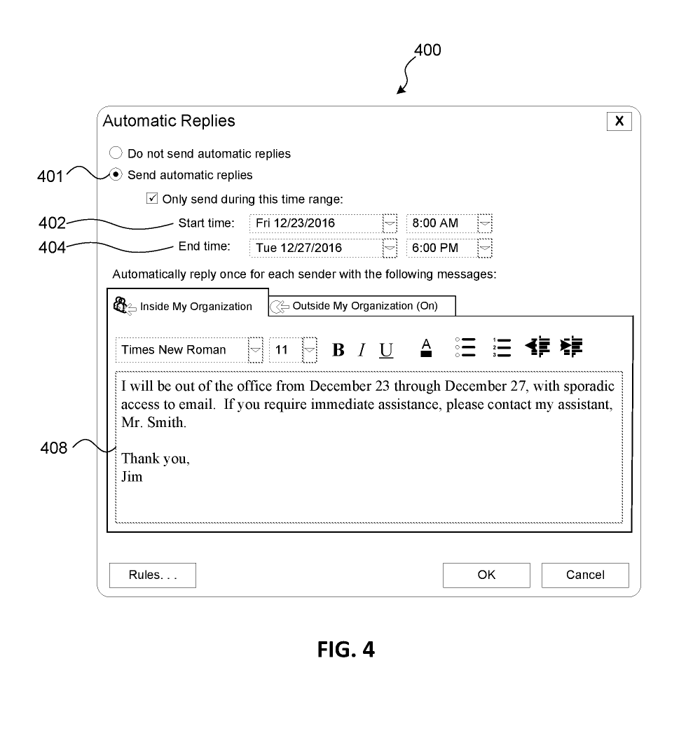

In some embodiments, the electronic processor 202 detects activation of the automatic reply based on user data stored in the database 104, which, as described above, may specify whether an automatic reply has been activated for a particular account. Alternatively or in addition, the electronic processor 202 detects activation of the automatic reply based on received user input. For example, the electronic processor 202 may receive user input that activates an automatic reply for an account and, optionally, specifies the duration for the automatic reply and text included in the reply. For example, FIG. 4 illustrates an example graphical user interface 400 for activating an automatic reply and, in particular, activating an out-of-office notification for an email account. The graphical user interface 400 may be displayed on a display device of the computer 106 communicating with the sever 102. As illustrated in FIG. 4, the user interface 400 includes an activation selection mechanism 401 for receiving user input that turns on or activates an automatic reply. The user interface 400 also includes a start time selection mechanism 402 and an end time selection mechanism 404 for receiving user input specifying a start time and an end time for the automatic reply. The user interface 400 may also include a text input mechanism 408 for receiving user input specifying text to be included in the automatic reply.

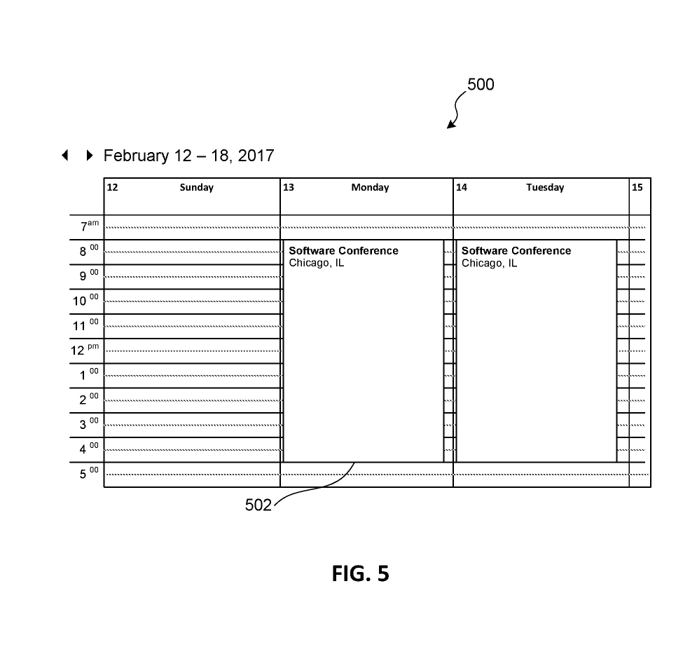

Alternatively or in addition, the electronic processor 202 may be configured to detect activation of the automatic reply by automatically activating the automatic reply in response to new calendar events. For example, the first user may add a calendar event to his or her electronic calendar that implies that the first user will be unavailable during the calendar event. For example, FIG. 5 illustrates an example graphical user interface 500 that displays an electronic calendar and, in particular, a calendar event 502. The calendar event 502 is entitled “Software Conference” and is categorized as “unavailable” time. Accordingly, in response to this calendar event 502, the electronic processor 202 may automatically activate the automatic reply for the account of the first user for the duration associated with the calendar event 502. In some embodiments, the electronic processor 202 may also automatically set the text of the automatic reply based on the calendar event 502. For example, using the example calendar event 502 illustrated in FIG. 4, the electronic processor 202 set the text of the automatic reply during this duration as “I will be at a Software Conference” from 8:00 AM on Monday February 13 through 5:00 PM on Tuesday, February 14 and will not be available during this time.”

It should be understood that, in other embodiments, the server 102 may detect activation of an automatic reply in response to other actions or inputs. For example, in some embodiments, the server 102 may be configured to automatically turn on automatic replies in response to particular conditions, such during after-hours, during holidays, during all department meetings, and the like. Similarly, it should be understood that the activation of the automatic reply may occur at the server 102 or a separate device or system that the server 102 communicates with.

Returning to FIG. 3, regardless of how the electronic processor 202 detects activation of the automatic reply, in response to detecting activation of the automatic reply, the electronic processor 202 determines a second user different from the first user (at block 304). The second user is an individual who may benefit from knowing, proactively, that the first user is unavailable. It should be understood that, in some embodiments, the second user represents a single user different than the first user. However, in other embodiments, the second user includes multiple users, wherein each user is different than the first user.

The electronic processor 202 may determine the second user using one or more different approaches. For example, the electronic processor 202 may set the second user to the first user's contacts, particular categories of the first user's contacts, or the like. Similarly, in some embodiments, the electronic processor 202 may receive user input from the first user specifying the second user. For example, the electronic processor 202 may generate a user interface that prompts the first user to enter or select the second user, such as by entering or selecting one or more email addresses. The electronic processor 202 may store this input from the first user and apply the input (automatically or after confirmation from the first user) when the automatic reply for the first user's account is subsequently activated.

In some embodiments, the electronic processor 202 may also automatically determine the second user based on message data associated with the first user, such as who the first user frequently communicates with. For example, the electronic processor 202 may access (from the database 104) a plurality of historical communications exchanged with the first user through the account of the first user (or other accounts associated the first user). The plurality of historical communications may include communications sent by the first user, received by the first user, or a combination thereof. The plurality of historical communications may include communications exchanged during a predetermined historical time period, such as the past day, week, 30 days, 90 days, and the like. Based on the plurality of historical communications, the electronic processor 202 determines a frequent correspondent. A frequent correspondent may be an individual that exchanges a number of communications with the first user that satisfies a predetermined threshold, such as an individual that exchanges more than 100 communications with the first user, exchanges at least one communication per day with the first user, or exchanges more than five communications within a week with the first user. Alternatively or in addition, a frequent correspondent may be an individual that exchanges the greatest number of communications with the first user or exchanges communications with the first user at the greatest rate among multiple correspondents. Regardless of how a frequent correspondent is determined, the electronic processor 202 may set the second user to the determined frequent correspondent. It should be understood that, in some embodiments, the electronic processor 202 determines multiple frequent correspondents and sets the second user to all or a subset of the determined frequent correspondents.

Alternatively or in addition, the electronic processor 202 may automatically determine the second user based on the importance of communications included in the plurality of historical communications. For example, the electronic processor 202 may determine an importance level for each of the plurality of historical communications and may set the second user to an individual associated with at least one of the plurality of historical communications that has an importance level that satisfies a predetermined threshold. In particular, the electronic processor 202 may set the second user to an individual that sent a communication to the first user or received a communication from the first user that was assigned a “high” importance level.

The importance level of a communication may be set by the sender of the communication, a recipient of the communication, or may be automatically assigned by the electronic processor 202. For example, the electronic processor 202 may assign an importance level based on whether a communication was associated with a read receipt, a number of recipients associated with a communication, a time of day the communication was sent, a number of replies to the communication, the type of communication, and the like. Also, in some embodiments, the electronic processor 202 may use natural language processing to analyze the content of the historical communications to determine an importance level of communications. The electronic processor 202 may also apply one or more rules, which may be manually configured, to assign the importance level. For example, based on the rules, the electronic processor 202 may assign a higher importance level to communications relating to business meetings than communications relating to social events. In some embodiments, the electronic processor 202 may look for particular keywords to determine what a communication relates to or what importance level to assign. For example, the electronic processor 202 may assign communications including certain keywords (for example, budget, sales forecast, human resources, and the like) or including certain individuals (for example, executive management) a higher importance level than communications not including those keywords or individuals. In some embodiments, the importance level of a communication may be set by the electronic processor 202 based on the how current a communication is. For example, when the first user corresponded with someone six months ago, such communications may not be as important as communications exchanged one week ago.

Alternatively or in addition, the electronic processor 202 may automatically determine the second user based on calendar data. For example, the electronic processor 202 may access (from the database 104) a plurality of calendar events associated with the first user, such as historical calendar events from the past month, three months, four months, or six months or future calendar events for the next month, three months, four months, or six months. Based on these calendar events, the electronic processor 202 may determine a frequent event participant. A frequent event participant may include an individual who was invited to, participated in, or both a calendar event associated with the first user. The electronic processor 202 may determine a frequent event participant as described above for determining a frequent correspondent. For example, a frequent event participant may be an individual who the first user frequently invites to meetings, an individual who is frequently invited to meetings along with the first user, or an individual who frequently invites the first user to meetings. Regardless of how a frequent event participant is determined, the electronic processor 202 may set the second user to the frequent event participant. Again, as noted above, the electronic processor 202 may determine multiple frequent event participants and may set the second user to all or a subset of the determined frequent event participants.

Alternatively or in addition, in some embodiments, the electronic processor 202 automatically determines the second user based on the organizational data. For example, the electronic processor 202 may access (from the database 104) organizational data associated the first user. The organizational data includes relationships between the first user and other individuals. For example, the organizational data may designate individuals who report to the first user, individuals to whom the first user reports, and the like. The organizational data may also designate what groups the first user is a member, such as departmental groups, committee groups, working groups, project groups, and the like, and other members of the group. Accordingly, the electronic processor 202 may set the second user to those individuals that the first user directly reports to, the first user's manager, one or more members of a group including the first user, or a combination thereof based on the organizational data.

It should be understood that the electronic processor 202 may perform the above approaches for determining the second user individually or in various combinations. For example, in some embodiments, the electronic processor 202 compares the organizational data to the frequent correspondents, frequent event participants, or both to determine the second user. For example, the first user may be part of a working group, but none of the members of the group may be a frequent correspondent or frequent event participant. In such case, the electronic processor 202 may not set the other members of the working group as second users. Also, in some embodiments, the server 102 allows a user, such as the first user or a system administrator, to manually configure what approaches the electronic processor 202 performs and settings for each approach, such as thresholds, keywords, and the like.

When, after using one or more of the approaches described above, the electronic processor 202 has determined second user, the electronic processor 202 automatically updates the electronic calendar of the second user to include a calendar event occurring over at least a portion of the duration (at block 306). The electronic processor 202 may update the electronic calendar by accessing the electronic calendar of the second and adding the calendar event to the electronic calendar. For example, when the second user is also a user of the server 102 (and has authorized such automatic updates), the electronic processor 202 may automatically update the electronic calendar of the second user by directly accessing the electronic calendar.

In other embodiments, the electronic processor 202 performs the update by generating the calendar event and transmitting the calendar event to a second account associated with the second user (such as an event invitation sent as an email message). When the second user receives the calendar event, the second user may accept the event, which adds the calendar event to the second user's electronic calendar. It should be understood that the second user may use messaging services and calendaring services provided by the server 102 or may use messaging services and calendaring services provided by a separate server or provided locally on a computing device. Accordingly, in some embodiments, the server 102 may transmit the generated calendar event to another email server that manages the second account associated with the second user.

The calendar event generated by the electronic processor 202 may specify the first user, the second user, or a combination thereof as a participant of the calendar event. The calendar event also includes a duration. The duration of the calendar event may be the duration of the activated automatic reply or a portion thereof. The calendar event may also include a time category. As noted above, since the calendar event marks the unavailability of the first user as compared to the second user, the calendar event may categorized as an “available” time. For example, assuming an automatic reply is activated for December 23 at 8:00 AM until December 27 at 6:00 PM, the associated calendar event may have the same duration or may have a duration that matches business hours for the organization for each of the days from December 23 through December 27. Accordingly, in some embodiments, the electronic processor 202 may be configured to generate multiple calendar events based on a single activation of an automatic reply.

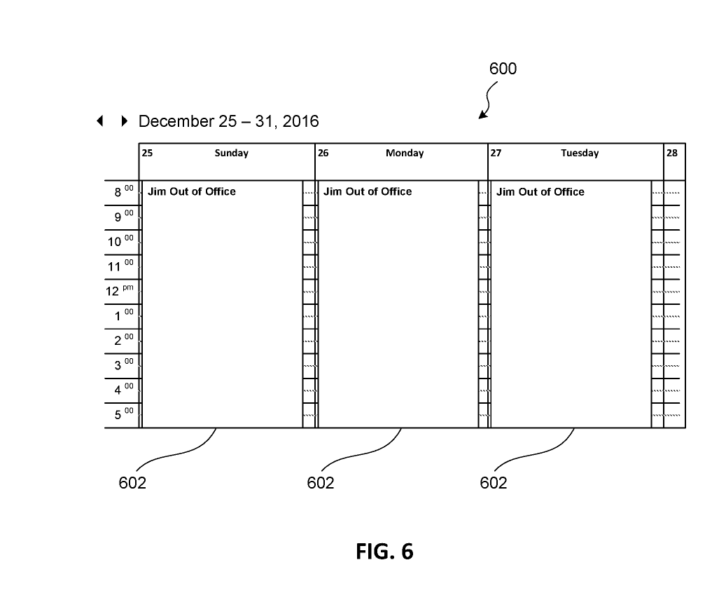

Regardless of how the electronic calendar is updated, the second user sees the calendar event when he or she accesses the electronic calendar. For example, FIG. 6 illustrates a graphical user interface 600 displaying an electronic calendar that includes calendar events 602 corresponding to the automatic reply illustrated in FIG. 4. In the example illustrated, the calendar events cover business hours during the time of the first user's unavailability. As noted above, in other embodiments, the duration of the calendar events on the second user's electronic calendar may be identical to the duration of the automatic reply.

In some embodiments, the electronic processor 202 may also be configured to automatically update an electronic calendar of the first user in response to activation of the automatic reply. The calendar event added to the first user's electronic calendar may be similar to the calendar event added to the second user's electronic calendar. However, the calendar event added to the first user's electronic calendar may be categorized as “busy” or “unavailable” time.

In some embodiments, the electronic processor 202 may also update calendar events that were automatically generated in response to activation of an automatic reply. For example, when the first user deactivates the automatic reply or updates the duration, text, or both of the automatic reply (for example, using the graphical user interface 400 illustrated in FIG. 4), the electronic processor 202 may automatically update the calendar event previously-added to the electronic calendar of the second user or may delete the previously-added calendar event and generate a new calendar event.

Embodiments have been described above in terms of a work environment. However, the systems and methods provided herein are applicable to academic, personal, and other environments where electronic calendaring and messaging are used to schedule events or coordinate time and efforts between two or more people. Embodiments have also been described in terms of users within the same organization. However, the systems and methods provided herein are applicable to users belonging to multiple organizations or to no organization.

Thus, embodiments provide, among other things, systems and methods for automatically updating an electronic calendar of a second user based on the activation of an automatic reply for a first user. As described above, the second user may be determined based on individuals who the first user frequently corresponds with, frequently meets with, who are on the same work team with the first user, or a combination thereof

Various features and advantages of some embodiments are set forth in the following claims.

What is claimed is:

1. A system for automatically updating an electronic calendar, the system comprising:
a server including an electronic processor configured to
detect an activation of an automatic reply for an account associated with a first user, the automatic reply associated with a duration;
in response to detecting the activation, determine a second user different from the first user; and
automatically update the electronic calendar of the second user to include a calendar event occurring over at least a portion of the duration.

2. The system of claim 1, wherein the calendar event is categorized as available time on the electronic calendar of the second user.

3. The system of claim 1, wherein the electronic processor is further configured to automatically update a second electronic calendar of the first user to include a second calendar event, wherein the second calendar event is categorized as unavailable time on the second electronic calendar of the first user.

4. The system of claim 1, wherein the electronic processor is configured to automatically update the electronic calendar of the second user by generating the calendar event and transmitting the calendar event to a second account associated with the second user for acceptance by the second user.

5. The system of claim 1, wherein the electronic processor is configured to determine the second user by
accessing a plurality of historical communications exchanged with the first user through the account of the first user;
determining a frequent correspondent based on the plurality of historical communications; and
setting the second user to the frequent correspondent.

6. The system of claim 1, wherein the electronic processor is configured to determine the second user by
accessing a plurality of historical communications exchanged with the first user through the account of the first user;
determining an importance level for each of the plurality of historical communications; and
setting the second user to an individual associated with at least one of the plurality of historical communications, wherein the importance level of the at least one of the plurality of historical communications satisfies a predetermined threshold.

7. The system of claim 1, wherein the electronic processor is configured to determine the second user by
accessing a plurality of calendar events associated with the first user;
determining a frequent event participant based on the plurality of calendar events; and
setting the second user to the frequent event participant.

8. The system of claim 1, wherein the electronic processor is configured to determine the second user by
accessing contact data associated with the first user; and
setting the second user to a contact of the first user included in the contact data.

9. A method for automatically updating an electronic calendar, the method comprising:
detecting, with an electronic processor, an activation of an automatic reply for an account associated with a first user, the automatic reply associated with a duration;
in response to detecting the activation of the automatic reply, determining, with the electronic processor, a second user different from the first user; and
automatically updating the electronic calendar of the second user to include a calendar event occurring over at least a portion of the duration and categorized as available time.

10. The method of claim 9, further comprising automatically updating a second electronic calendar of the first user to include a second calendar event, wherein the second calendar event is categorized as unavailable time on the second electronic calendar of the first user.

11. The method of claim 9, wherein automatically updating the electronic calendar of the second user includes generating the calendar event and transmitting the calendar event to a second account associated with the second user for acceptance by the second user.

12. The method of claim 9, wherein determining the second user includes receiving user input from the first user specifying the second user.

13. The method of claim 9, wherein determining the second user includes
accessing a plurality of historical communications exchanged with the first user through the account of the first user;
determining a frequent correspondent based on the plurality of historical communications; and
setting the second user to the frequent correspondent.

14. The method of claim 9, wherein determining the second user includes
accessing a plurality of calendar events associated with the first user;
determining a frequent event participant based on the plurality of calendar events; and
setting the second user to the frequent event participant.

15. The method of claim 9, wherein determining the second user includes
accessing contact data associated with the first user; and
setting the second user to a contact of the first user included in the contact data.

16. The method of claim 9, wherein determining the second user includes
accessing organizational data associated with the first user; and
setting the second user to a member of a group including the first user based on the organizational data.

17. A non-transitory computer-readable medium including instructions executable by an electronic processor to perform a set of functions, the set of functions comprising:
detecting an activation of an automatic reply for an account associated with a first user, the automatic reply associated with a duration during which the first user is unavailable to receive communications through the account;
in response to detecting the activation of the automatic reply, determining a second user different from the first user, wherein the second user represents a frequent correspondent with the first user via the account associated with the first user; and
automatically updating an electronic calendar of the second user to include a calendar event occurring over at least a portion of the duration and categorized as available time.

18. The non-transitory computer-readable medium of claim 17, wherein detecting the activation of the automatic reply includes automatically activating the automatic reply in response to user input creating a second calendar event within a second electronic calendar of the first user.

19. The non-transitory computer-readable medium of claim 17, wherein automatically updating the electronic calendar of the second user includes transmitting the calendar event to a second account associated with the second user for acceptance by the second user.

20. The non-transitory computer-readable medium of claim 17, wherein the set of functions further comprises automatically updating a second electronic calendar of the first user to include a second calendar event, wherein the second calendar event is categorized as unavailable time on the second electronic calendar of the first user.
